(19) United States
(12) Patent Application Publication
(10) Pub. No.: US 2005/0156425 A1
(43) Pub. Date: Jul. 21, 2005

(54) Fastener for display page

(76) Inventors: Scott D. Pearson, Woodbury, MN (US); Gary A. Albrecht, Mahtomedl, MN (US); Gerald E. Mueller, Eagan, MN (US); Joy A. Packard, Somerset, WI (US); Steven E. Turch, Blaine, MN (US); Dale R. Wiehe, Lake Elmo, MN (US)

Correspondence Address: 3M INNOVATIVE PROPERTIES COMPANY, PO BOX 33427, ST. PAUL, MN, 55133-3427, US

(21) Appl. No.: 11/011,867

(22) Filed: Dec. 14, 2004

Related U.S. Application Data
(60) Provisional application No. 60/585,063, filed on Jul. 2, 2004.
(60) Provisional application No. 60/530,592, filed on Dec. 18, 2003.

(51) Int. Cl. B42D 1/00

(52) U.S. Cl. 281/21.1

(57) ABSTRACT

A fastener for attachment to articles in craft applications includes a gripping space for engaging a display article in the gripping space. One example of the fastener of the present invention includes a base, a support post, at least one gusset, and a cap. The base has an upper face and a substantially flat lower face. The support post is connected to the upper face of the base, and projects therefrom. The at least one gusset is connected to the support post. The cap has an outer face and an inner face, where the inner face of the cap is connected to the support post. The cap is disposed substantially parallel to the base, and extends over a portion of the at least one gusset. The cap is spaced from the base.

### CROSS-REFERENCE TO RELATED APPLICATIONS

This application claims priority from U.S. Provisional Application Ser. No. 60/585,063 filed Jul. 2, 2004, which claims priority from U.S. Provisional Application Ser. No. 60/530,592, filed Dec. 18, 2003. Both provisional applications are incorporated herein by reference in their entirety.

### BACKGROUND OF THE INVENTION

The present invention relates to fasteners. More particularly, the present invention relates to fasteners for use with display pages.

Most generally, display pages are used with a book, album, binder or other holder that allows users to store, organize and preserve scrapbook articles such as photographs, newspaper clippings, decorative papers, certificates, medals and other mementoes and memorabilia.

A scrapbook is a collection of one or more pages (e.g., display pages or scrapbook pages), each of which usually contains at least photographs, writings, decorative elements, memorabilia or the like. Most often, pages in the scrapbook are grouped by a common theme, such as a family vacation, wherein photographs and page embellishments are creatively and aesthetically arranged to preserve memories (reflected in the photographs) and enhance sharing with other persons. Often, a user making the scrapbook desires to create a family heirloom that will last for generations.

A user (or “scrapbooker”) typically attaches articles to a scrapbook page using a variety of specialized tapes, glues and adhesives, and it can be a very time consuming process while waiting for glues and adhesives to dry sufficiently. For example, photographs and decorative papers are often attached with pressure sensitive adhesives or glue sticks. Non-cellulosic embellishment articles such as ribbon, raffia and wire are typically much more difficult to place and challenging to attach, and such methods as hot melt adhesives or vinyl acetate glues are used, although with limited success. Because these methods involve a direct adhesive or glue attachment between the embellishment articles and the scrapbook page, the scrapbooker is often concerned regarding long-term preservation of the articles due to deterioration caused by the adhesive or glue. It is undesirable to have any contact (or a substantial risk of contact) between the adhesive or glue and the scrapbook and embellishment articles. Furthermore, it is often desirable to remove a memorabilia item during sharing of the scrapbook, for example to view a medal, and then return it to the scrapbook page, and the adhesive or glue methods generally do not accomplish this well.

Occasionally, scrapbookers utilize items such as brads and nail heads that are affixed to a scrapbook page by methods such as puncturing the scrapbook page and bending or deforming a portion of the fastener (typically deforming a portion of the fastener that protrudes through the scrapbook page), which secures them to the scrapbook page. This method is often undesirable because it requires damaging the scrapbook page, which can, in turn, lead to damage of articles stored on the scrapbook page. In addition, this method can leave sharp points exposed, which can damage adjacent scrapbook pages (and the articles stored on those adjacent pages).

Items used to affix scrapbook and embellishment articles can have sharp points, corners and otherwise have non-smooth and non-rounded features. Because a typical scrapbook includes a number of display pages positioned adjacent each other like a book, contact between the non-smooth and non-rounded items and other objects can cause damage to, for example, adjacent display pages and display and embellishment articles affixed thereon.

Another problem faced by scrapbookers is the time required to assemble, affix, arrange, decorate and organize a display page for a scrapbook. It is undesirable to spend considerable time gluing, knotting, wrapping and performing other attachment operations to secure display and embellishment articles on a display page. Such attachment operations can be undesirably complicated.

There is, therefore, a need to for an improved way of securely, conveniently, quickly and creatively providing means to attach the items and elements of a scrapbook to the page. It is also desired to enhance the ability to easily remove and return items to a scrapbook page. It is still further desired to provide a fastener that contributes to the preservation of items on a scrapbook page and the scrapbook itself.

Thus, the present invention relates to fasteners that provide an alternative means of securing articles on a display page in a scrapbook or in other locations.

### BRIEF SUMMARY OF THE INVENTION

A decorative fastener for attachment to articles in craft applications according to the present invention includes a base having a lower planar face, an upper section projecting from the display sheet. The lower planar face is aligned to face a display sheet. The upper section includes first and second opposed surfaces, which cooperate to define a frictional gripping space therebetween for engaging an embellishment article within the gripping space. The upper section of the base has smooth surfaces and rounded edges on exposed exterior portions thereof. The upper section of the base is free from adhesive which might contact the embellishment article. A layer of adhesive is disposed on the lower planar face of the base for affixing the base to the display sheet.

Another embodiment of a fastener for use on a display sheet includes a first surface and an angled protrusion connected to the first surface. An acute angle gripping space is formed between the first surface and the angled protrusion for engaging a display article or an embellishment article in the gripping space. In one embodiment, the fastener is affixed to a craft application article by means of a pressure sensitive adhesive thereon.

Another embodiment of a fastener for attachment to articles in craft applications according to the presentinvention includes a base, a support post, at least one gusset, and a cap. The base has an upper face and a substantially flat lower face. The support post is connected to the upper face of the base, and projects therefrom. The at least one gusset is connected to the support post. The cap has an outer face and an inner face, where the inner face of the cap is connected to the support post. The cap extends over a portion of the at least one gusset, and is spaced from the base.

Another embodiment of a fastener for use on a display page includes a base, a raised portion, and a channel. The base has an upper face and a substantially flat lower face. The raised portion is connected to the upper face of the base, and the raised portion includes an outer perimeter. The channel is disposed in the raised portion, creating a pathway between two points along the outer perimeter of the raised portion for securing articles in the channel by a friction fit.

Another embodiment of the present invention is a fastener for use on a display page. The fastener includes a base, a raised portion, and a cap. The base has an upper face and a substantially flat lower face. The raised portion is connected to the upper face of the base. The raised portion includes an outer perimeter. The cap has an inner face and an outer face, and the cap is capable of operative engagement with the raised portion for securing materials between the cap and the base.

Another embodiment of a fastener for use on a display page includes a base, first and second angled faces, a cap, first and second gripping spaces, and one or more projections. The base has a substantially flat bottom face. The first and second angled faces are disposed at opposing ends of the base and are generally perpendicular to the opening. The angled faces depend generally downward. The cap is connected to the base, and the cap has a first end and a second end. Further, the cap has a lower surface on the first end of the cap that extends above the first angled face forming the first gripping space therebetween, and the cap has a second end of the cap that extends above the second angled face forming the second gripping space therebetween. At each opposing end of the base, the lower surface or the angled face has one or more projections thereon that extend into the respective gripping space.

Another embodiment of the present invention relates to a fastener for use on a display page. The fastener includes an upper leg, a lower leg, and a spring-like hinge. The upper leg has a top surface and a bottom contact surface. The lower leg includes a substantially flat lower surface capable of accepting an adhesive material and an opposite upper contact surface. The upper contact surface of the lower leg is disposed to face the bottom contact surface of the upper leg. The upper and lower legs are operably connected to the spring-like hinge. The bottom contact surface of the upper leg extends along substantially the entire upper leg.

### BRIEF DESCRIPTION OF THE DRAWINGS

FIG. 1 is a top view of a display page bearing a plurality of fasteners of the present invention thereon.

FIG. 2 is a perspective view of an exemplary embodiment of a fastener of the present invention and an embellishment article such as a strand of thread.

FIG. 3 is a front elevational view of the fastener of FIG. 2.

FIG. 4 is a side elevational view of the fastener of FIG. 2.

FIG. 5 is a bottom plan view of the fastener of FIG. 2.

FIG. 6 is a perspective view of another embodiment of an inventive fastener.

FIG. 7 is a top plan view of the fastener of FIG. 6.

FIG. 8A is a perspective view of another embodiment of an inventive fastener.

FIG. 8B is a front elevational view of the fastener of FIG. 8A.

FIG. 9A is a schematic side elevational view of another embodiment of an inventive fastener.

FIG. 9B is a schematic side elevational view of another embodiment of an inventive fastener.

FIG. 10 is a perspective view of another embodiment of an inventive fastener.

FIG. 11 is a perspective view of another embodiment of an inventive fastener.

FIG. 12 is a side elevational view of the fastener of FIG. 11.

FIG. 13 is a perspective view of another embodiment of an inventive fastener.

FIG. 14 is a perspective view of another embodiment of an inventive fastener.

FIG. 15 is a perspective view of another embodiment of an inventive fastener.

FIG. 16 is a simplified sectional view of the fastener of FIG. 15, with a length of an embellishment article retained therein.

FIG. 17 is a perspective view of another embodiment of an inventive fastener.

FIG. 18 is a front elevational view of the fastener of FIG. 17.

FIG. 19 is a top plan view of the fastener of FIGS. 17 and 18.

FIG. 20 is a perspective view of another embodiment of an inventive fastener.

FIG. 21 is a side elevational view of the fastener of FIG. 20, with an embellishment article retained therein.

FIG. 22 is perspective view of another embodiment of an inventive fastener.

FIG. 23 is a side elevational view of the fastener of FIG. 22, with an embellishment article retained therein.

FIG. 24 is a perspective view of another embodiment of an inventive fastener.

While the above-identified drawing figures set forth several embodiments of the invention, other embodiments area also contemplated, as noted in the discussion. In all cases, this disclosure presents the invention by way of representation and not limitation. It should be understood that numerous other modifications and embodiments can be devised by those skilled in the art, which fall within the scope and spirit of the principles of the invention. The figures may not be drawn to scale. Like reference numbers have been used throughout the figures to denote like parts.

### DETAILED DESCRIPTION

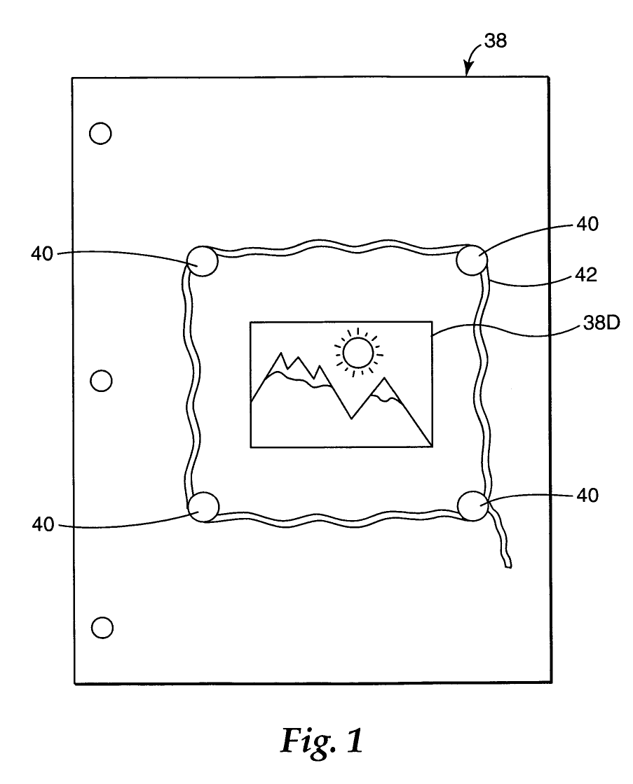

FIG. 1 is a top view of a display page 38. The display page 38 can be any sheet or substrate that is suitable for decoration, such as pages and covers of scrapbooks, photo albums, cards, journals, books, portfolios, notebooks, binders and similar items. Scrapbook articles such as photographs, newspaper clippings, medals, certificates and other memorabilia can be affixed to the display page 38. An exemplary scrapbook article 38D is shown affixed to the scrapbook page 38. One or more fasteners 40 (also called tie downs) are affixed to the display page 38, and a display or embellishment article 42 (hereinafter sometimes referred to simply as “thread 42”) is attached to one or more of the fasteners 40. As shown in FIG. 1, four fasteners 40 are affixed to the display page 38 and are arranged around the scrapbook article 38D to define, in combination with the thread 42, a decorative border about the article 38D.

Generally, the fasteners 40 are suitable for attachment to various items (e.g., the display page 38) in craft applications, such as in scrapbooking, card-making, or similar activities. Display and/or embellishment articles such as thread, wire, raffia, ribbon, string, yarn, chain, lace, photographs, decorative papers, decorative fabrics and other scrapbook articles can be mechanically secured to the fasteners 40, by friction-fit as described below. Such articles can be used in a decorative way to tailor the presentation of scrapbook items already secured to the display page 38 and/or can be used in a functional way to secure scrapbook items, in whole or in part, to the display page 38. As shown in FIG. 1, an embellishment article such as a thread 42 is secured between the four fasteners 40 in an exemplary decorative arrangement (i.e., as a decorative border). Exposed portions of each of the fasteners 40 are substantially free of adhesives, so that the display and embellishment articles are secured to the fastener 40 without contacting any adhesive (or even creating a substantial risk of contacting any adhesives). Contact between an adhesive and display and embellishment articles is undesirable, as such contact can cause deterioration and damage to those articles.

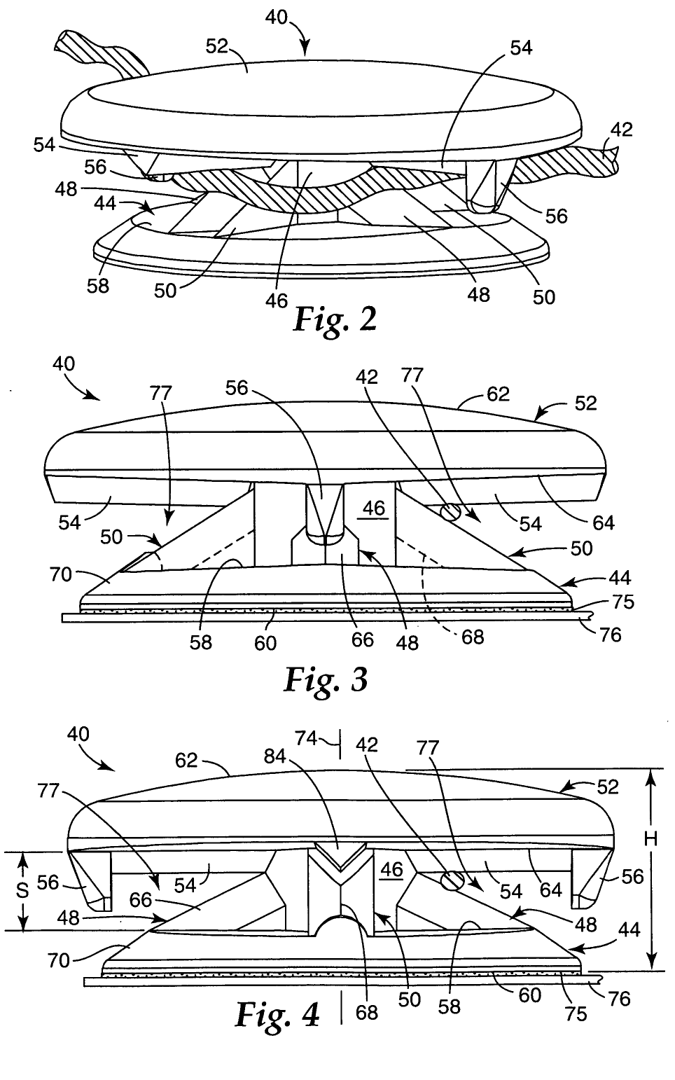

FIG. 2 is a perspective view of an embodiment of the fastener 40 and an embellishment article such as a piece of thread or yarn 42. The fastener 40 includes a base 44, a support post 46, a pair of first gussets 48, a pair of second gussets 50 (only one of which is shown in FIG. 2), a cap 52, a ridge 54 aligned relative to each gusset, and a pair of retaining projections 56. According to the present invention, a gusset is defined as a formation that provides a gripping surface. A gusset may generally take on numerous shapes for this purpose, for example, triangular, curvilinear, cone-shaped, rectangular, cylindrical, and other two- and three-dimensional shapes.

FIG. 3 is a front elevational view of the fastener 40 and FIG. 4 is a side elevational view of the fastener 40. As seen in FIGS. 2 and 3, the base 44 of the fastener 40 includes an upper face 58 and a substantially flat lower face 60. The cap 52 includes an outer face 62 and an inner face 64. The first gussets 48 each include, on upper faces thereof, a convex V-shaped operative surface 66. The second gussets 50 each include, on upper faces thereof, a concave V-shaped operative surface 68. In one embodiment, the base 44 is chamfered about its periphery, and includes a chamfered portion 70. As shown in FIG. 4, the fastener 40 has an overall height H. The overall height H is generally relatively small, thereby providing a relatively low profile. For example, the overall height of a typical fastener can be about 0.25 inch (0.635 cm) or about 0.375 inch (0.9525 cm), so it has a relatively low profile. The inner face 64 of the cap and the upper face 58 of the base 44 are spaced a distance S. The distance S is typically in the range of about 0.003 inch (0.00762 cm) to about 0.5 inch (1.27 cm). In a one embodiment, the distance S is 0.08 inch (0.2032 cm). The relatively low profile of the fastener 40 facilitates attachment within a scrapbook having a plurality of adjacent pages, where adjacent display pages (and embellishment articles secured thereon) may contact the fastener 40.

The base 44 of the fastener 40 of FIGS. 1-4 is disc-shaped, although the base 44 can be of nearly any shape (e.g, rectangular, decorative shapes such as stars, ovals, floral, and animal shapes, etc.). The lower face 60 of the base 44 is capable of bearing an adhesive thereon, and is generally capable of attachment to an article such as a display page.

The support post 46 is connected to the upper face 58 of the base 44, and projects therefrom. In one embodiment, the support post 46 is aligned to be substantially orthogonal to the upper face 58 of the base 44.

The cap 52 is disposed substantially parallel to the base 44 and spaced from the base 44. The inner face 64 of the cap 52 is connected to the support post 46. The cap 52 generally extends over at least a portion of at least one of the gussets. In the embodiment shown in FIGS. 1-4, the cap 52 extends over all of the gussets 48-50. The cap 52 can be disc-shaped. In further embodiments, the cap 52 can be of nearly any shape (e.g, rectangular, decorative, etc.). Generally, the outer face 62 of the cap 52 is substantially smooth. In one embodiment, the outer face 62 of the cap 52 has a smooth arcuate shape. Smoothness of an upper section of the fastener 40 (e.g., along the outer face 62 of the cap 52) is significant for avoiding damage to display or embellishment articles and adjacent scrapbook pages (which may contact the fastener 40). A scrapbook may contain a plurality of individual scrapbook pages positioned adjacent one another, like pages of a book. Smoothness avoids sharp corners and points that can cause damage to display or embellishment articles and adjacent scrapbook pages disposed in close proximity to the fastener 40. A relatively large surface area of the fastener 40 (i.e., of the upper section and of the cap 52) distributes pressure where the fastener 40 contacts other objects such as adjacent display pages and display or embellishment articles, thereby minimizing potential pressure points and other concerns with poking, embossing or otherwise damaging the adjacent display page and any articles secured thereto. Moreover, the fastener 40 has smooth surfaces and rounded edges on exposed exterior portions thereof.

One or more gussets connected to the support post 46 can be included with the fastener 40. The first and second gussets 48 and 50 are merely exemplary representations. The fastener 40 shown in FIGS. 1-3 include the pair of first gussets 48, which are disposed to radiate outwardly from the support post 46 in a collinear alignment, and are connected between the support post 46 and the upper face 58 of the base 44. The fastener 40 further includes the pair of second gussets 50, which are also disposed to radiate outwardly from the support post 46 in a collinear alignment, and are connected between the support post 46 and the upper face 58 of the base 44. The first and second gussets 48 and 50 are, in one embodiment, aligned perpendicular to each other.

Each of the first gussets 48 has the convex V-shaped operative surface 66 thereon, which forms a single raised ridge extending generally upwardly from the first gusset 48. Each second gusset 50 has the concave V-shaped operative surface 68 thereon, which forms a pair of generally parallel raised ridges extending generally upwardly from the second gusset 50. These operative surfaces provide enhanced gripping and frictional characteristics for display or embellishment articles that are wedged against them. In further embodiments, the convex and concave portions may take on other shapes (e.g., a U-shape or serrated). In still further embodiments, a gusset can have other shapes, for instance, a gusset can have a three-dimensional cone-like shape and can wrap around the support post 46.

An axis 74 (FIG. 4) is defined through a center of the support post 46. Relative to the axis 74, the first and second gussets 48 and 50 radially extend outwardly from the support post 46. In one embodiment, at least two of the gussets 48 and 50 are circumferentially spaced apart.

The ridges 54 are disposed along the inner face 64 of the cap 52. Relative to the axis 74, the ridges 54 radially extend outwardly from the support post 46. In one embodiment, at least one of the ridges 54 is disposed opposite at least one of the first or second gussets 48 or 50, in a generally parallel alignment therewith. Like the operative surfaces on the gussets, the ridges can have V-shapes (as shown) or other shapes, textures or surface topography to enhance gripping and frictional characteristics for display or embellishment articles that are wedged against them.

Each retaining projection 56 is disposed on the inner face 64 of the cap 52. In one embodiment, each retaining projections 56 extends substantially orthogonal to the inner face 64 of the cap 52, and is disposed at an outer end of one of the ridges 54. In one embodiment, two retaining projections 56 are provided on the fastener 40, and the two retaining projections 56 are disposed 180° from each other (relative to the axis 74). In a further embodiment, one or more retaining projections are disposed elsewhere on the fastener 40, such as on the upper face 58 of the base 44. The retaining projections 56 are provided to further ensure the retention of a display or embellishment article relative to the fastener 40.

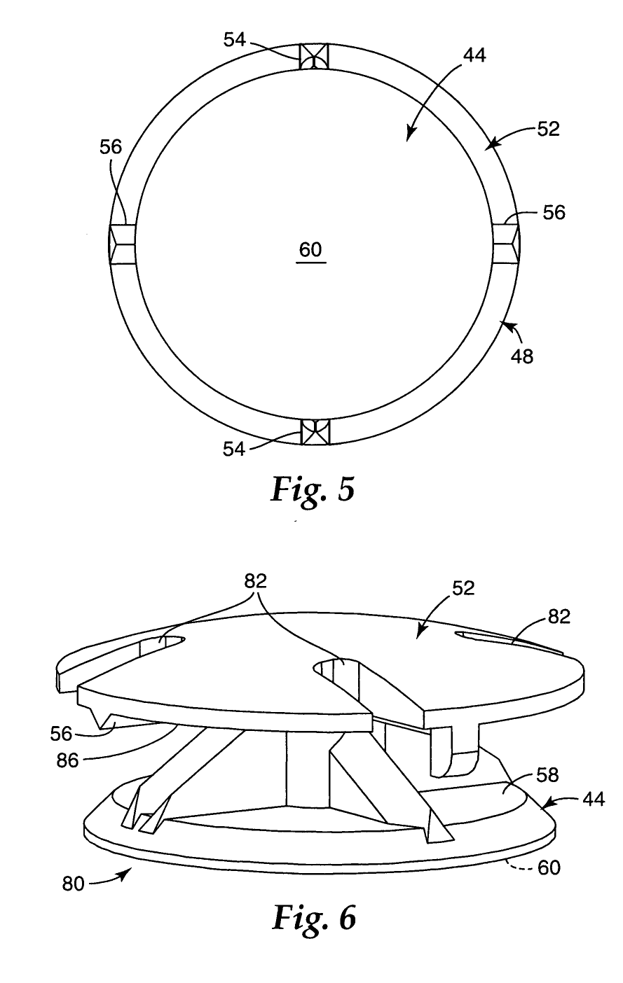

FIG. 5 is a bottom plan view of the fastener 40. As seen in FIGS. 2-5, at least a portion of a periphery of the cap 52 extends beyond a periphery of the base 44. In one embodiment, the disc-shaped cap 52 is radially larger than the disc-shaped base 44. In the embodiment shown in FIG. 5, the cap 52 and the base 44 are co-axially aligned relative to the axis 74.

The fastener 40 can be formed of an injection-moldable plastic material, such as thermoplastic elastomers (e.g., santoprene), polyolefins (e.g., polypropylene and polyethylene), polyamides, polyurethanes, K-resin (a styrene-butadiene copolymer), or a modified version of those materials. In one embodiment, the fastener 40 is formed of a high surface energy polymer that does not require special treatments or adhesives to bond. For instance, preferred materials include high-impact polystyrene, polycarbonate, and acryl butyl styrene (ABS). In further embodiments, the fastener 40 can be formed of other materials, such as machined metals.

The fastener can be formed of a plastic material bearing a dye or pigment of a particular color, such as blue. In one embodiment, the fastener 40 is capable of retaining ink and paint thereon, for adding decorative colors and patterns. Generally, the materials listed above for forming the fastener 40 are acceptable for accepting ink and paint, though some materials better accept inks and paints (e.g., polystyrene) than others (e.g., polyolefins). The particular material chosen will vary according to the particular inks and paints desired to be used with the fastener 40. In further embodiments, decorative coloring or patterning is provided on the fastener 40 in ink and paint. For instance, a decorative design (e.g., a floral image or pattern) can be provided on the outer face 62 of the cap 52 of the fastener 40. In still further embodiments, decorative embellishment, such as decorative fabric, paper, etc., can be affixed to the the outer face 62 of the cap 52.

The lower face 60 of the base 44 is generally capable of accepting an adhesive 75 (such as illustrated in FIGS. 3 and 4), such as any double-side tape or transfer adhesive. The adhesive 75 is typically applied to the lower face 60 of the base 44, though the adhesive 75 can be applied to other components as well in further embodiments.

The adhesive 75 can be a permanent or removable adhesive. Removable adhesives are typically repositionable pressure sensitive adhesives. Preferably, adhesives for use with scrapbooks are acid-free and photograph safe. For instance, adhesives can be acid-free and photograph safe ionomeric adhesives, such as an iso-acrylate (IOA)/acrylamide/sodium styrene sulphonate (NaSS) adhesive that is acid-free and photograph safe. Where double-sided tape is used, the tape can include a polyester film carrier coated on both sides with the same adhesive. Those skilled in the art will recognize that other types of adhesives, such as glues and hot melt adhesives, can also be utilized.

In FIG. 3, a removable release liner 76 is also shown over the adhesive 75. When the fastener is to be placed on a display page, the release liner 76 is removed to expose the adhesive 75. In one embodiment, the release liner 76 is coated paper, such as a paper liner commercially designated “Printed (In Red) Bleached ‘2-4OBKG-1 & 99AM’ Silicone Coated Paper”, available from DCP-Lohja, Dixon, Ill. In another embodiment, the release liner 76 is a differential release polyester liner, such as the polyester liner commercially designated “Polyester Film 0.001 mil Differential Silicone coated (Nat 1.0 PET Silox H1K/H3G)”, available from Akrosil Corp., Menasha, Wis.

The inventive fasteners can be provided with one or more individual fasteners disposed on a single release liner. A user can then separate a desired number of fasteners from the release liner, which exposes a pressure sensitive adhesive on the fasteners. The user can then affix each fastener in a desired location, such as on a display page (see, e.g., photo sheet 38 in FIG. 1), using the adhesive, and secure display and embellishment articles to the fastener as desired.

In operation, a user can adhesively affix the fastener 40 to display pages such as scrapbook pages, cards, and similar items utilized in craft applications (see, e.g., FIG. 1). Additional articles and materials (e.g., display articles and embellishment articles) can be attached onto a display page using one or more of the fasteners 40. For instance, as illustrated in FIGS. 1 and 2, an embellishment article such as a strand of thread or yarn 42 can be mechanically removably secured to the fastener 40 by positioning a portion of the thread 42 between the cap 52 and the base 44.

Articles and materials such as the thread 42 are typically secured to the fastener 40 by a friction-fit (the following discussion of the operation of the fastener 40 applies equally to the thread 42 and to other similar materials that may be engaged with the fastener 40). A friction-fit is generally any clamping, mechanical interference, gripping, or other frictional engagement. Engaging the thread with the fastener 40 involves positioning the thread 42 between fastener components such as the upper face 58 of the base, the inner face 64 of the cap 52, the first and second gussets 48 and 50, the ridges 54, and the retaining protrusions 56. Enhanced gripping is provided where the thread 42 is positioned, for example, between the single raised ridge of the convex V-shaped operative surface 66 of one of the first gussets 48 and one of the V-shaped ridges 54 on the inner face 64 of the cap 52. Opposed faces cooperate to define a frictional gripping space therebetween for engaging an embellishment article. A gripping region 77 (FIGS. 3 and 4) formed between a gusset and its associated ridge, along with shaped contours of the opposed surfaces of the gusset and ridge, effectively creates a channel that narrows (e.g., in a V-shape) for providing a desirable friction fit for securing the thread 42 to the fastener 40. By pulling the thread 42 tightly into the channel, the gripping region 77 creates a pinching effect to provide a more positive engagement of the thread 42 to the fastener 40. This allows an article to be secured to the fastener 40 without requiring wrapping around the fastener 40, making knots or ties, or placing adhesives in contact with the article. The gripping region 77 has a narrowing shape, which permits embellishment articles having a variety of diameters and thicknesses to be secured to the fastener 40.

The retaining protrusions 56 minimize a risk of unwanted disengagement of the thread 42. In other words, the retaining protrusions 56 act as obstacles for preventing the thread 42 from becoming accidentally unsecured or unwrapped from the fastener 40. In one embodiment, each of the retaining protrusions 56 is shaped such that it is easier to slide the thread 42 past the protrusion 56 inwardly than outwardly. For example, the protrusion can be shaped like a barb, can be inwardly-angled, and may further include barbs disposed on the protrusion 56.

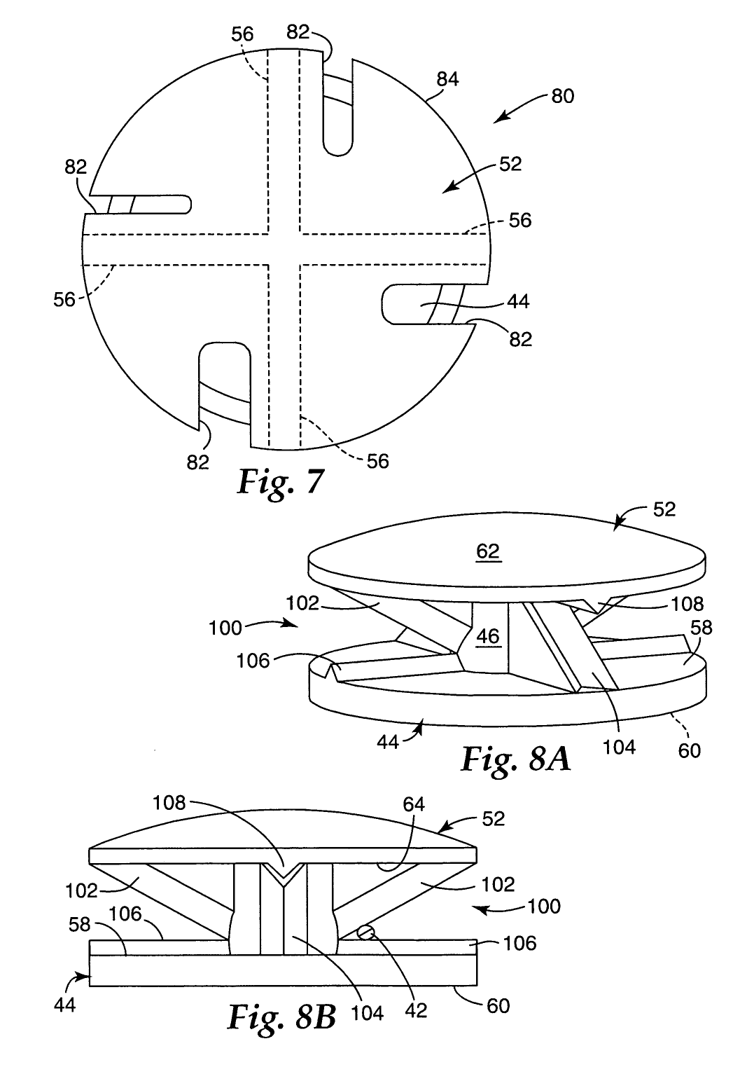

FIG. 6 is a perspective view of an alternative embodiment of an inventive fastener 80. FIG. 7 is a top plan view of the fastener 80. The fastener 80 is substantially similar to the fastener 40 shown and described with respect to FIGS. 1-5. The fastener 80 further includes one or more slots 82 disposed in the cap 52. The slots 82 generally extend inward from an outer edge 84 of the cap 52. In one embodiment (shown in FIG. 6), an outer end of each of the slots 82 is open at a periphery of the cap 52 for sliding articles (e.g., a thread) into the slot 82. The slots 82 can be arranged in any desired orientation, such as radially aligned or, as shown in FIG. 7, substantially parallel to the ridges 56 that are disposed on the inner face 58 of the cap 52.

The slots 82 provide further means for gripping of an embellishment article (e.g., a thread) that a user seeks to secure to the fastener 80. In this embodiment, a thread can also be secured to the fastener, at least in part, by a friction fit within one or more of the slots 82. Moreover, articles can be threaded through multiple slots (as well as wrapped around other components of the fastener 80) for more positive securing of articles to the fastener 80. As seen in FIG. 7, the slots 82 can have different widths, to accommodate different types of display or embellishment articles (e.g., a wider slot for yarn or ribbon and a narrower slot for string or thread).

FIG. 8A is a perspective view of an alternative embodiment of an inventive fastener 100. FIG. 8B is a front elevational view of the fastener 100. As shown in FIGS. 8A and 8B, the fastener 100 includes features similar to those of the fasteners 40 and 80 described above. The fastener 100 includes first gussets 102, second gussets 104 (only one of which is visible in each of FIGS. 8A and 8B), first ridges 106 and second ridges 108.

In this embodiment, the first gussets 102 are connected between the inner face 64 of the cap 52 and the support post 46. The second gussets 104 are connected between the upper face 58 of the base 44 and the support post 46. The first ridges 106 are disposed on the upper face 58 of the base 44. The second ridges 108 are disposed on the inner face 64 of the cap 52. In one embodiment, the first ridges 106 are substantially aligned with the first gussets 102, and the second ridges 108 are substantially aligned with the second gussets 104. In further embodiments, other arrangements are possible.

In operation, the fastener 100 functions in a similar manner to the fasteners 40 and 80, described above. Embellishment articles can be secured to the fastener 100 mechanically or otherwise. Embellishment articles, such as the thread 42, can be can be positioned tortuously across one or more of the gussets 102 and 104, and pinched into V-shaped gripping spaces that are formed on the fastener 100.

The fasteners 80 and 100 likewise bear adhesive on the lower face 60 of the base 44 of each fastener, such as described above with respect to the fastener 40 of FIGS. 1-5.

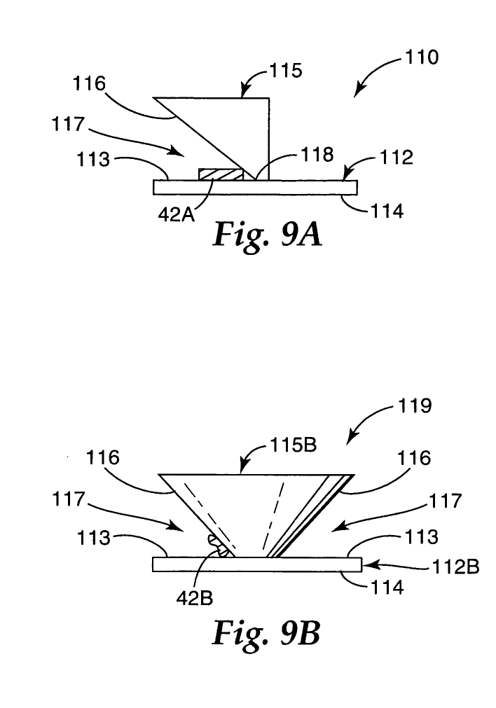

FIG. 9A is a schematic side elevational view of an alternative embodiment of an inventive decorative fastener 110. The decorative fastener includes a base portion 112 having a first surface 113 and a second surface 114, with the second surface 114 bearing an adhesive thereon for affixing the fastener 110 to a display page. Angled protrusion 115 projects from the first surface 113 of the base 112, and includes a contact face 116. The protrusion is aligned such that the contact face 116 is disposed at an acute angle with respect to the first surface 114 of the base portion 112. A gripping space 117 is thus formed between the first surface 113 and the contact face 116 of the angled protrusion 115 for the reception and holding of a length of a display or embellishment article, such as an article 42A, therein.

The angled protrusion 115 can assume any shape and configuration, so long as an effective gripping space is defined on the fastener 110. For example, the angled protrusion 115 can be a gusset, a post, a cap, or other formation that extends from the first surface 113 of the base 112. The angled protrusion 115 may extend in a single direction, multiple directions, or in an arc about the base, or may even extend, for example, in a circle about the circular (or disc-shaped) base portion 112, as indicated in FIG. 9B.

Typically, the gripping space 117 forms a channel that narrows toward an inner end 118 of the gripping space 117. A display article or an embellishment article (e.g., the article 42A) is positioned in the gripping space 117, and is generally positioned to contact at least the contact face of the angled protrusion 115, for mechanically engaging at least a portion of the article in the gripping space 117. More particularly, the article can be secured by a frictional or mechanical interference fit, with a wedge formed by the acute angle between the angled protrusion 115 and the first surface 113 of the base 112. Either the first surface 113 or the contact face 116 of the angled protrusion 115 may include surface texture, gripping surfaces, and topography features that enhance the frictional characteristics of the surfaces or their cooperative characteristics.

FIG. 9B is a schematic side elevational view of an alternative embodiment of an inventive fastener 119, with a display or embellishment article 42B (e.g., a ribbon) engaged therewith. The fastener 119 is similar to the fastener 110 shown in FIG. 9A. The fastener 119 includes an angled protrusion 115B that extends in a circle about a disc-shaped base portion 112B. The fasteners 110 and 119 generally bear adhesive on the second surfaces 114 of the base 112 of each fastener, such as described above with respect to the fastener 40 of FIGS. 1-5.

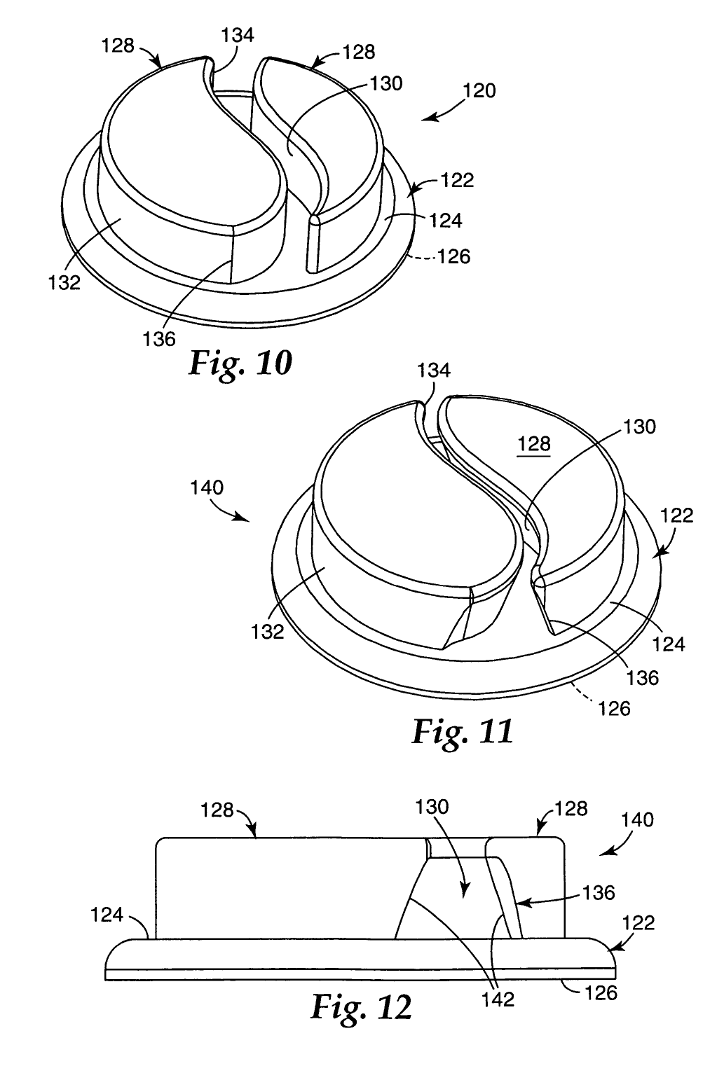

FIG. 10 is a perspective view of an alternative embodiment of an inventive fastener 120. The fastener 120 includes a base 122 having an upper face 124 and an opposite substantially flat lower face 126, a raised portion 128, and a channel 130. The raised portion includes an outer perimeter 132.

The raised portion 128 is connected to the upper face 124 of the base 122 (i.e., the raised portion 128 is part of an upper section of the fastener 120). The channel 130 is disposed in the raised portion 128, creating a pathway between two openings 134 and 136 along the outer perimeter 132. In one embodiment, the channel 130 has an arcuate shape. In another embodiment, the channel 130 has a serpentine shape. The pathway formed by the channel 130 is capable of mechanically securing display or embellishment articles (e.g., a strand of thread or yarn) in the channel 130, such as by a friction or mechanical interference fit. Moreover, portions of articles larger than the channel 130 can be deformed within the channel 130 for securing the article therein.

Articles and materials such as a thread are typically secured to the fastener 120 by a friction and mechanical interference. The pathway through the channel 130 creates a gripping space therein. Positioning a portion of the thread within gripping space of the channel 130 permits contact between the thread and walls of the channel 130 to frictionally engage the thread to the fastener 120. This enables the thread to be secured to the fastener 120 without the need for knots, stoppers, glues and other adhesives or for wrapping the thread around the fastener 120. The thread may further contact components such as the upper face 124 of the base 122. Enhanced gripping is provided where the thread 42 is, for example, biased within the channel 130. Embodiments with an arcuate or serpentine channel can promote biasing of the thread within the gripping space of the channel 130. A knot or other enlargement on the thread, which is larger than a width of the channel 130, can be further used to secure the thread to the fastener 120.

A user can affix the fastener 120 to a display page or other location in a desired arrangement. The user can position the channel 130 of the fastener 120 (e.g., rotationally) in a manner such that articles secured in the gripping space of the channel 130 are positioned in a desired arrangement relative to the display sheet (or other location).

FIG. 11 is a perspective view of an alternative embodiment of an inventive fastener 140. FIG. 12 is a side elevational view of the fastener 140. The fastener 140 is generally similar to the fastener 120. The channel 130 of the fastener 140 further includes side walls 142, where at least a portion of one or both of the side walls 142 is canted, meaning that a portion of the wall 142 is disposed at an angle other than 90° with respect to the upper face 124 of the base 122. The canted wall 142 can be shaped to provide enhanced gripping of articles secured in the channel 130, and the channel 130 is then narrower at its to than at its bottom, thus further enhancing its ability to retain a length of an article such as a strand of ribbon or yarn therein.

A depth of the channel 130 can extend entirely through the raised portion 128. In further embodiments, the depth of the channel 130 can extend only partially through the raised portion 128.

The fasteners 120 and 140 likewise bear adhesive on the lower face of the base 122 of each fastener, such as described above with respect to the fastener 40 of FIGS. 1-5.

In further embodiments, the fasteners 120 and 140 can further include a cap (not shown) that is permanently or removably attached to the raised portion 128 such that the raised portion 128 is disposed between the cap and the base 122, thereby covering the channel 130 and whatever might be disposed therein (e.g., thread, ribbon, chain, etc.).

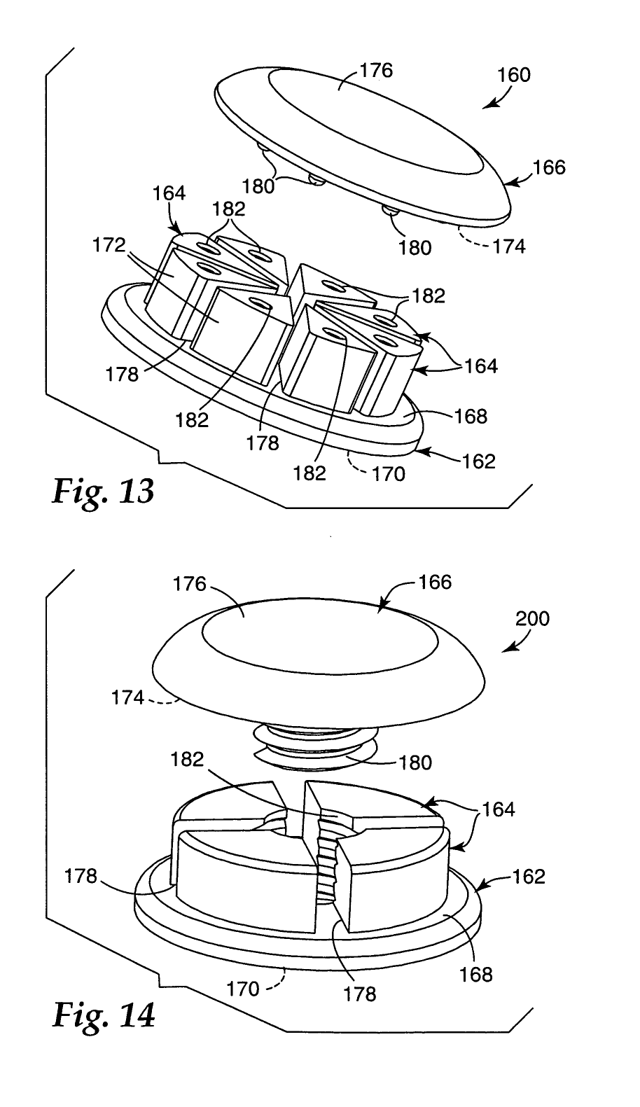

FIG. 13 is a perspective view of an alternative embodiment of an inventive fastener 160 (a two-part fastener), which includes a base 162, a raised portion 164, and a cap 166. The base 162 includes an upper face 168 and an opposite substantially flat lower face 170. The raised portion 164 is connected to the upper face 168 of the base 162. The raised portion 164 includes an outer perimeter 172. The cap 166 has an inner face 174 and an opposite outer face 176. The cap 166 is capable of operative engagement with the raised portion 164 for securing materials between the cap 166 and the base 162. In one embodiment, the fastener 160 further includes at least one channel 178 disposed in the raised portion 164. Each channel 178 creates a pathway between channel openings spaced along the outer perimeter 172 of the raised portion 164. The one or more channels 178 can have straight, arcuate, serpentine, and intersecting shapes, and the channels 178 can have nearly any depth in the raised portion 164.

In another embodiment, the fastener 160 further includes at least one post 180, which extends from the inner face 174 of the cap 166, and a corresponding number of post-receiving openings 182 disposed in the raised portion 164. The posts 180 are capable of engagement with the post-receiving openings 182 for securing the cap 166 relative the base 162 (i.e., securing the cap 166 to the raised portion 164). Typically, the posts 180 and the corresponding post-receiving openings 182 engage by a friction or mechanical interference fit. In various embodiments, the posts 180 and the post-receiving openings 182 can permanently engage each other, or can be removably engaged.

In operation, a user can place an article, such as a thread, through pathways or gripping spaces formed by the one or more channels 178. A variety of methods, similar to those described above, can be used to secure articles to the fastener 160. The user can then engage the cap 166 with the raised portion 164 to secure the article (e.g., the thread) between the cap 166 and the base 162. The cap 166, once so secured, reduces the possibility that the article will become disengaged from the one or more channel 178.

The fastener 160 bears adhesive on the lower face 170 of the base 162, such as described above with respect to the fastener 40 of FIGS. 1-5. The fastener 160 can be affixed to a display page with the adhesive.

FIG. 14 is a perspective view of an alternative embodiment of an inventive fastener 200 (a two-part fastener), which is similar to the fastener 160. In the embodiment of the fastener 200 shown in FIG. 14, only one post 180 and one post-receiving opening 182 are included. The post 180 is generally disposed in a center of the cap 166. The post 180 and the post-receiving opening 182 are threaded, for cooperative threaded engagement therebetween. In operation, a user can threadedly secure the cap 166 relative to the base 162 (i.e., secure the cap 166 to the raised portion 164).

Similar to the manner described with respect to the fastener 160 of FIG. 13, a user can secure an article, such as a thread, between the cap 166 and the base 162 of the fastener 200. The article (e.g., the thread) can be secured, at least in part, by frictional contact with the threaded post 180, when the cap 166 and the base 162 are assembled.

The fastener 200 bears adhesive on the lower face 170 of the base 162, such as described above with respect to the fastener 40 of FIGS. 1-5. The fastener 200 can be affixed to a display page with the adhesive.

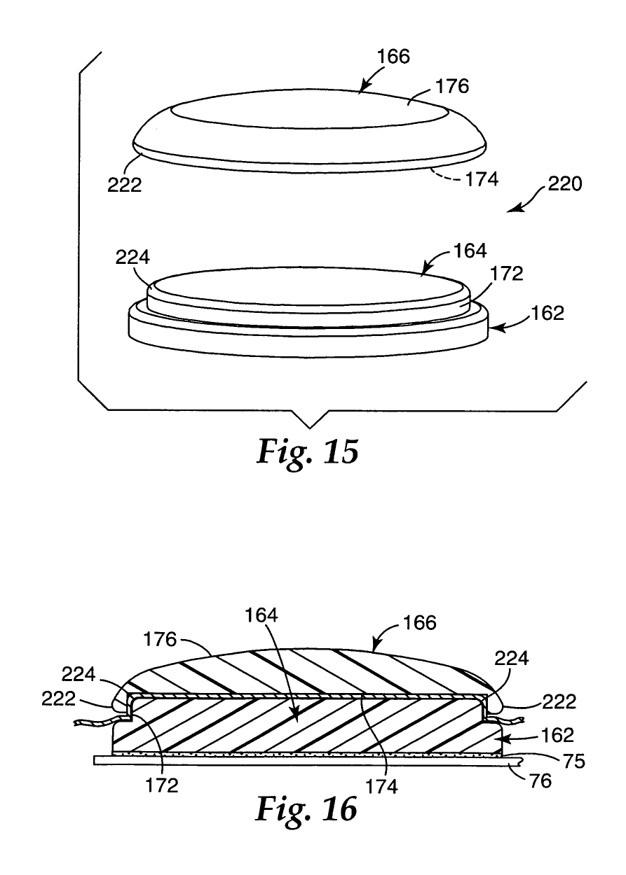

FIG. 15 is a perspective view of another two-part inventive fastener 220. The fastener 220 is generally similar to the fasteners 160 and 200 shown and described above. The fastener 220 further includes a first lip 222 and a second lip 224. The first lip is generally disposed at a perimeter of the cap 166. The second lip 224 is generally disposed along the outer perimeter 172 of the raised portion 164, disposed at or near an upper edge thereof. The first and second lips 222 and 224 are capable of operative engagement for securing the cap 166 to the raised portion 164. Operative engagement can be direct or indirect engagement. Where operatively engaged, the first lip 222 essentially envelops the second lip 224, which mechanically secures or clips the cap 166 to the raised portion 164. The first lip 222 may deflect slightly while operatively engaged.

FIG. 16 is a simplified sectional view of the assembled two-part fastener 220 and a thread 42, which is engaged thereto. As seen in FIG. 16, indirect engagement of the first lip 222 and the second lip 224 occurs where the thread 42 creates a space between at least portions of the first and second lips 222 and 224. The thread 42 is merely an exemplary representation of an article that could be secured between the cap 166 and the base 162 of the fastener 220.

The fastener 220 bears adhesive on the lower face 170 of the base 162, such as described above with respect to the fastener 40 of FIGS. 1-5. The fastener 220 can be affixed to a display page with the adhesive.

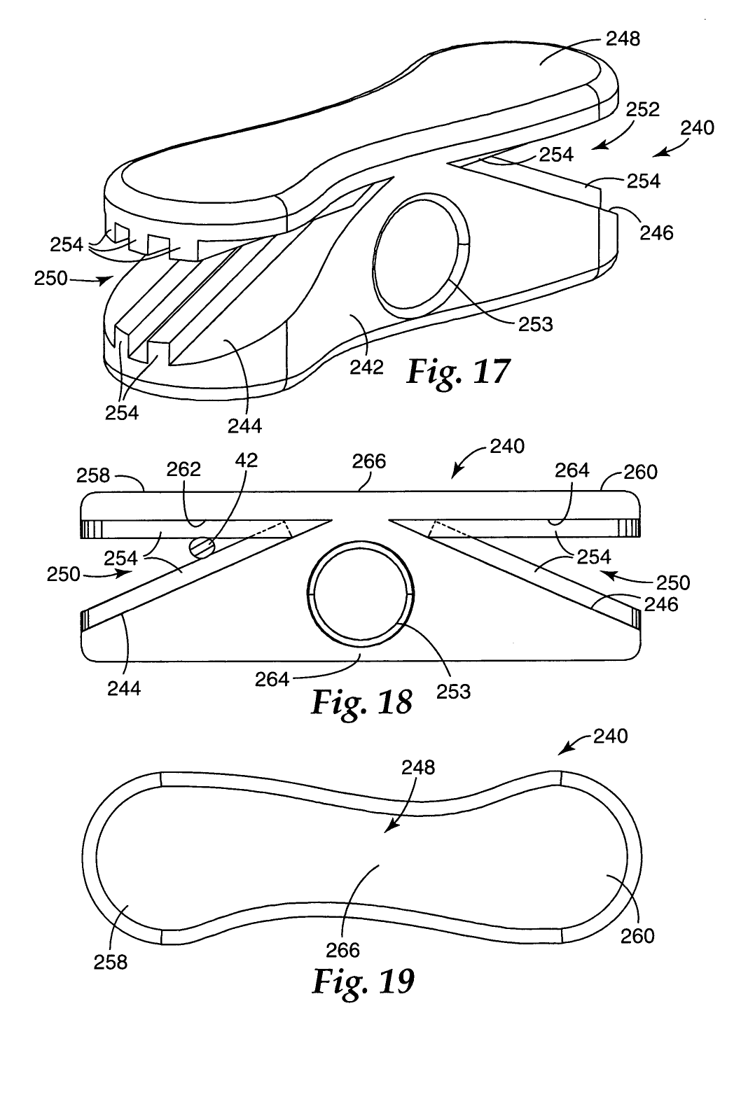

FIG. 17 is perspective view of an alternative embodiment of an inventive fastener 240. FIG. 18 is a front elevational view of the fastener 240, and FIG. 19 is a top plan view of the fastener 240. The fastener 240 includes a base 242, first and second angled faces 244 and 246, a cap 248, first and second gripping spaces 250 and 252, an opening 253, and projections 254.

The base 242 has a substantially flat bottom face 256. The first and second angled faces 244 and 246 are disposed at opposing ends of the base 242 (i.e., for as part of an upper section of the fastener 240) and are generally perpendicular to the opening 253. The first and second angled faces 244 and 246 depend generally downward (i.e., away from the cap 248). The first and second angled faces 244 and 246 are disposed on the base 242, and contact the cap 248 adjacent an intermediate portion of the fastener 240. The cap 248 is connected to the base 242, and the cap 248 has a first end 258 and a second end 260. The cap 248 has a lower surface or face 262 on the first end 258 of the cap 248 that extends above the first angled face 244, thereby forming the first gripping space 250 therebetween, and the cap 248 has a second end 260 that extends above the second angled face 246, thereby forming the second gripping space 252 therebetween. The opening 253 extends through a middle portion 264 of the base 242. At each end of the base 242, the angled face 244 or 246 has one or more projections 254 thereon that extend into the respective gripping space 250 and/or 252.

In one embodiment, the first and second ends 258 and 260 of the cap 248 are wider than a middle portion 266 of the cap 248. Similarly, opposing ends of the base 242 can be wider than the middle portion 264 of the base 242. In one embodiment, as shown in FIG. 19, the fastener 240 has a curvilinear “dog-bone” or “barbell” type shape.

Nearly any number of projections 254 can be included with the fastener 240. Moreover, the projections 254 can be of nearly any shape and arrangement. The projections 254 generally function to increase a surface area of portions of the fastener 240 capable of frictional contact with articles a user desires to secure to the fastener 240. For example, the projections can be grooves, ridges, and other formations that extend into one or more of the gripping spaces 250 and 252. In one embodiment, projections 254 along a gripping space (e.g., the first gripping space 250) form a cooperative pattern of opposed projections 254 (or opposed projections and grooves).

In operation, similar to embodiments shown and described above, a user can affix the fastener 240 to a display page or other suitable location with adhesive disposed on the lower face 256 of the base 242. The user can secure articles, such as a thread 42, by frictionally engaging the article with one or more of the gripping spaces 250 and 252. Moreover, the user can wrap articles about the fastener 240 to secure them to the fastener 240. In addition, articles can be secured using the opening 253. Appropriately sized articles can be threaded through the opening 253 and secured by wrapping the article about the fastener 240 and gripping the article in one or more of the gripping spaces 250 and 252. The user can also knot an end of the article or place a stopper on the article, such that the article become functionally larger than the opening 253, for securing the article through the opening 253 and to the fastener 240.

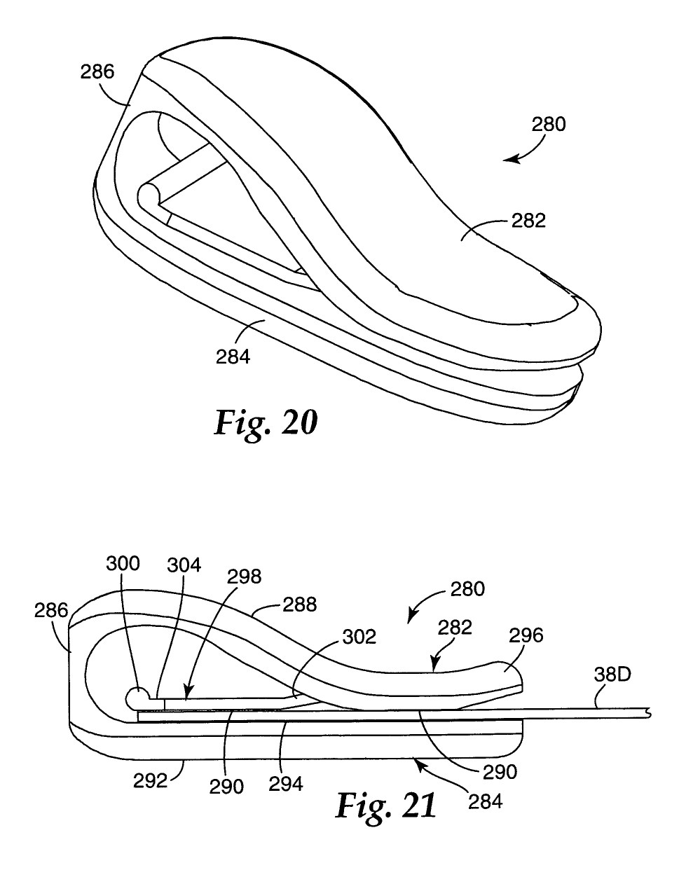

FIG. 20 is a perspective view of an alternative embodiment of an inventive fastener 280 (also called a clamp). FIG. 21 is a side elevational view of the fastener 280 and a display or embellishment article 38D (e.g., a photograph) secured thereto. The fastener 280 includes an upper leg 282, a lower leg 284, and a spring-like hinge 286 connecting the upper and lower legs 282 and 284. The upper leg 282 has a top surface 288 and a bottom contact surface 290. The lower leg 284 includes a substantially flat lower surface 292 capable of accepting an adhesive material and an opposite upper contact surface 294. The upper leg 282 further includes an upturned gripping portion 296 (where “upturned” means angling away from the lower leg 284) to facilitate opening of the clamp or entry of an article therein.

The bottom contact surface 290 of the upper leg 282 further includes an inner leg extension 298 and a cylindrical inner edge 300 formed on the leg extension 298. The bottom contact surface 290 of the upper leg 282 extends along substantially the entire upper leg 282. The bottom contact surface 290 generally extends along both the upper leg 282 and the leg extension 298, providing an area for frictional contact with articles such as the photograph 38D. The upper contact surface 294 of the lower leg 284 is disposed to face the bottom contact surface 290 of the upper leg 282. Opposed faces (e.g., the bottom contact surface 290 and the upper contact surface 294) of the clamp-like fastener 280 cooperate to define a frictional gripping space therebetween (e.g., a gripping space on an upper section of the fastener 280) for engaging a display or embellishment article. The upper and lower legs 282 and 184 are operably connected to the spring-like hinge 286. The leg extension 298 has a first end 302 and a second end 304. The bottom contact surface 290 of the upper leg 282 generally extends along the leg extension 298. The first end 302 of the leg extension 298 is joined with the bottom contact surface 290 of the upper leg 282. In one embodiment, the cylindrical edge 300 is formed at or near the second end 304 of the leg extension 298. In another embodiment, the second end 304 of the leg extension 298 extends toward the spring-like hinge 296.

The cylindrical edge 300 provides a smoother edge, for avoiding damage to article engaged with the fastener 280. In further embodiments, the second end 304 of the leg extension 298 can have other shapes, such as an arcuate shape.

In one embodiment, the fastener 280 is elongate, having length greater than width (where length is defined in the general direction of movement of the spring-like hinge 286). In another embodiment (shown in FIGS. 20 and 21), the upper leg 282 is curved between the spring-like hinge 286 and the upturned gripping portion 296.

In one embodiment, the upturned gripping portion 296 is disposed opposite the spring-like hinge 286. The spring-like hinge 286 generally biases the upper leg 282 toward the lower leg 284. A thickness of the spring-like hinge 286 is selected to provide a desired magnitude of biasing. Positioning the upturned gripping portion 296 away from the spring-like hinge 286 can provide a mechanical advantage to a user seeking to lift the upper leg 282 in opposition to biasing from the spring-like hinge.

In operation, an applied opening force, such as a user-supplied force, can be used to temporarily increase separation between the upper and lower legs 282 and 284 in order to increase spacing between the bottom contact surface 290 of the upper leg 282 and the upper contact surface 294 of the lower leg 284. A user can lift the upper leg 282 by grasping the upturned gripping portion 296 of the upper leg 282, while the lower leg 284 is adhered to a substrate (e.g., a display page).

After the applied opening force is removed, the spring-like hinge 286 generally biases the bottom contact surface 290 of the upper leg 282 (generally including at least a portion of the upper leg 282 and/or the leg extension 298) and into contact with the display or embellishment article 38D. At least a portion of the embellishment article 38D is thereby secured between the bottom contact surface 290 of the upper leg 282 and the upper contact surface 294 of the lower leg 284. The clamp of FIGS. 20 and 21 will likewise serve to secure an embellishment article such as a strand of yarn or ribbon onto a display page.

The leg extension 298 generally functions to more positively engage the display article 38D with the fastener 280. The leg extension 298 can increase an available contact area on the bottom contact surface 290. In addition, the leg extension can also transmit at least a portion of a biasing force from the spring-like hinge 286 to portions of a display article 38D engaged with the fastener 280.

The embellishment article 38D can be disengaged from the fastener 280 by generally providing an applied opening force to the upper leg 282 and removing the embellishment article 38D. Thus, various articles can be repeatedly engaged and disengaged from the fastener 280 with a minimal risk of damage to the various articles.

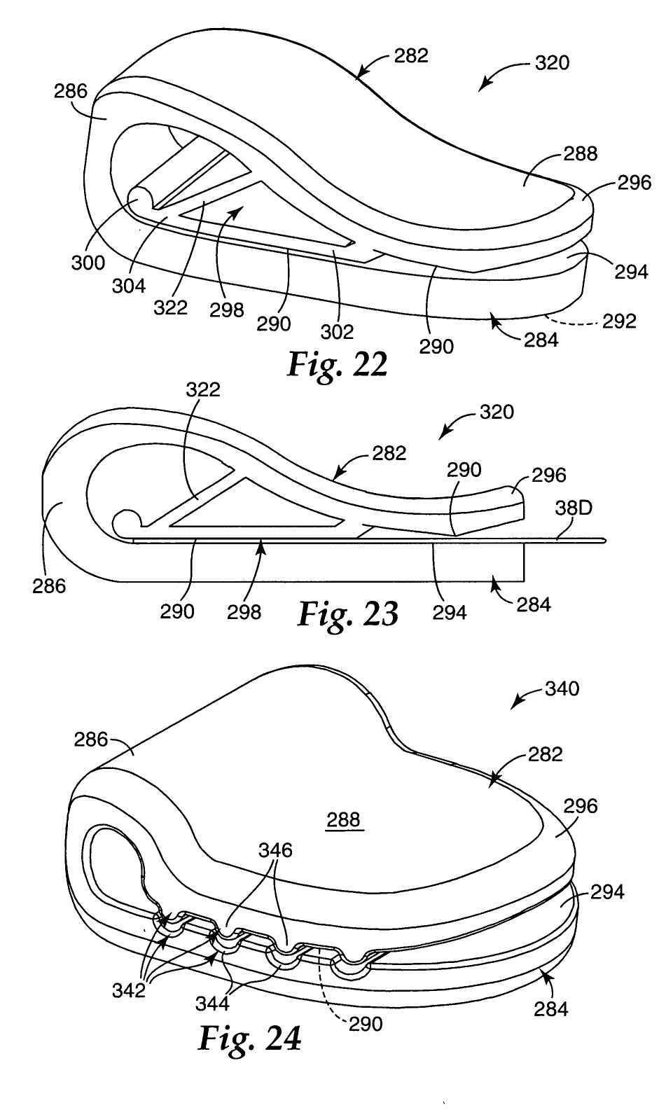

FIG. 22 is perspective view of an alternative embodiment of an inventive fastener 320. FIG. 23 is a side elevational view of the fastener 320 and an embellishment article 38D engaged therewith. The fastener 320 is similar to the fastener 280, wherein opposed faces of the clamp-like fastener 320 cooperate to define a frictional gripping space therebetween for engaging a display or embellishment article.

In this embodiment, the fastener 320 further includes a bracing member 322 connected to the upper leg 282 and to the leg extension 298 at or near its second end 304. In further embodiments, the bracing member 322 can be connected or operatively engaged with any portion of the leg extension 298.

The bracing member 322 can help to provide additional bias force to the bottom contact surface 290 of the upper leg 282. More particularly, the bracing member 322 can be positioned such that increased biasing to the embellishment article 38D is provided at the bottom contact surface 290 along at least a portion of the leg extension 298, thereby providing increased biasing to the frictional gripping space.

FIG. 24 is a perspective view of an alternative embodiment of an inventive fastener 340. The fastener 340 is generally similar to the fasteners 280 and 320 shown and described above, wherein opposed faces of the clamp-like fastener 340 cooperate to define a frictional gripping space therebetween for engaging a display or embellishment article. The fastener 340 further includes a gripping pattern 342.

The gripping pattern 342 is typically a textured or formed pattern that provides an enhanced frictional surface on portions of the fastener 340, such as on the bottom contact surface 290 of the upper leg 282 and the upper contact surface 294 of the lower leg 284. In one embodiment, the gripping pattern provides an enhanced frictional surface along the gripping space.

The gripping pattern 342 can comprise complimentary surface topographies disposed over the bottom contact surface 290 of the upper leg 282 and/or the upper contact surface 294 of the lower leg 284. In one embodiment, the surface topography of the gripping pattern 342 includes one or more raised protrusions 344 and one or more grooves 346, disposed along the upper contact surface 294 of the lower leg and/or the lower contact surface 290 of the upper leg 282. In further embodiments, the surface topography can include other friction-enhancing formations and various surface shapes (e.g., U-shaped, V-shaped), as well as with textures (e.g., a knurled or other frictional texture that will not damage articles gripped by the fastener 340).

The surface topography is generally capable of operative engagement for gripping materials and articles disposed therebetween (i.e., disposed between the one or more raised protrusions 344 and the one or more grooves 346). Portions of the surface topography, such as at least one of the raised protrusions 344 and at least one of the grooves 346, can be arranged for cooperative engagement. For instance, at least one of the raised protrusions 344 can be positioned substantially in alignment with at least one of the grooves 346. The surface topography can have nearly any arrangement, such as in linear stripes, chevron stripes, and various other patterns designed to provide desired frictional characteristics.

In one embodiment, the spring-like hinge 286 has a quasi-cylindrical shape, meaning that the spring-like hinge 286 may have a deformed cylindrical shape and/or may not be closed (e.g., it may resemble a C-shape).

The fasteners 280, 320 and 340 likewise bear adhesive on the lower surfaces 292 of the lower legs 284 of each fastener, such as described above with respect to the fastener 40 of FIGS. 1-5. The fasteners 280, 320 and 340 likewise can be formed of injection-moldable materials, such as those described above with respect to the fastener 40 of FIGS. 1-5. Thicknesses of the fasteners 280, 320 and 340 can likewise be dimensionally stabilized to overcome brittleness concerns with the injection-moldable material.

For all the embodiments of the inventive fastener detailed above, display and embellishment articles can be secured to each fastener without contacting an adhesive (or creating a substantially risk of contacting an adhesive). The fasteners likewise have generally smooth surfaces and rounded edges on exposed exterior portions thereof to minimize damage to any objects that may contact any of the fasteners. Thus, after a fastener is affixed to a display sheet, it serves as a smooth, low-profile and effective frictional fastener, which is easy to use and provides a relatively quick means for securing a display or embellishment article onto the display sheet.

Although the present invention has been described with reference to preferred embodiments, workers skilled in the art will recognize that changes may be made in form and detail without departing from the spirit and scope of the invention. For instance, the shape of the caps or clamps can vary to be disc-shaped, rectangular, or decorative (e.g., flower-shaped).

1. A fastener for use on a display page, the fastener comprising:
a base having an upper face and a substantially flat lower face;
a support post connected to the upper face of the base, and projecting therefrom;
at least one gusset connected to the support post; and
a cap having an outer face and an inner face, the inner face of the cap being connected to the support post, wherein the cap extends over a portion of the at least one gusset, and wherein the cap is spaced from the base.

2. The fastener of claim 1, wherein the outer face of the cap has a smooth arcuate shape.

3. The fastener of claim 1, wherein the at least one gusset is connected to the inner face of the cap.

4. The fastener of claim 1, wherein the at least one gusset is connected to the upper face of the base.

5. The fastener of claim 1 and further comprising a first gusset and a second gusset, the first gusset having a convex V-shaped portion, and the second gusset having a concave V-shaped portion.

6. The fastener of claim 1 and further comprising a ridge disposed on the inner face of the cap or the upper face of the base.

7. The fastener of claim 6, wherein the ridge is disposed opposite the at least one gusset, in alignment therewith.

8. The fastener of claim 1, and further including a slot disposed in the cap, wherein the slot extends inward from an outer edge of the cap.

9. The fastener of claim 8, wherein the inner face of the cap further comprises a ridge, and wherein the slot is disposed substantially parallel to the ridge.

10. The fastener of claim 1 and further comprising at least one retaining projection.

11. The fastener of claim 10 wherein at least one retaining projection is connected to the inner face of the cap, and wherein the at least one retaining projection is disposed substantially orthogonal to the inner face of the cap.

12. The fastener of claim 1, wherein the base is chamfered.

13. The fastener of claim 1, wherein at least a portion of a periphery of the cap extends beyond a periphery of the base.

14. The fastener of claim 1 and further comprising an adhesive material applied to the lower face of the base.

15. The fastener of claim 14, wherein the adhesive material is selected from the group consisting of an acid-free and photograph-safe adhesive, a repositionable pressure sensitive adhesive, and a permanent adhesive.

16. The fastener of claim 1, wherein at least one of the cap and the base is disc-shaped.

17. The fastener of claim 1, wherein the support post is disposed substantially orthogonal to the upper face of the base.

18. The fastener of claim 1, wherein the fastener accepts ink and painting.

19. A fastener for use on a scrapbook page, the fastener comprising:
a base having an upper face and a substantially flat lower face;
a raised portion connected to the upper face of the base, the raised portion including an outer perimeter; and
a channel disposed in the raised portion, wherein the channel creates a pathway between two openings along the outer perimeter of the raised portion for securing articles in the channel by a friction fit.

20. The fastener of claim 19, wherein the channel has an arcuate shape or serpentine shape.

21. The fastener of claim 19, wherein a wall of the channel is canted.

22. A fastener for use on a scrapbook page, the fastener comprising:
a base, wherein the base has a substantially flat bottom face;
first and second angled faces disposed at opposing ends of the base, wherein the angled faces depend generally downward;
a cap connected to the base, the cap having a first end and a second end, wherein the cap has a lower surface on the first end of the cap that extends above the first angled face forming a first gripping space therebetween, and the cap has a second end of the cap that extends above the second angled face forming a second gripping space therebetween; and
at each opposing end of the base, the lower surface or the angled face has one or more projections thereon that extend into the respective gripping space.

23. The fastener of claim 22, wherein the cap has a middle portion, and the first and second ends of the cap are wider than the middle portion of the cap.

24. The fastener of claim 22, wherein the base has opposing ends and a middle portion, and wherein the ends of the base are wider than the middle portion.

25. The fastener of claim 22 and further comprising an opening through the base.

26. The fastener of claim 25, wherein the opening is located in the middle portion of the base.

27. A clamp for use on a scrapbook page, the clamp comprising:
an upper leg having a top surface and a bottom contact surface;
a lower leg, wherein the lower leg includes a substantially flat lower surface capable of accepting an adhesive material and an opposite upper contact surface, the upper contact surface of the lower leg disposed to face the bottom contact surface of the upper leg;
a spring-like hinge, wherein the upper and lower legs are operably connected to the spring-like hinge;
wherein the bottom contact surface of the upper leg extends along substantially the entire upper leg.

28. The clamp of claim 27, wherein the spring-like hinge has a quasi-cylindrical shape.

29. The clamp of claim 27, wherein the bottom contact surface of the upper leg comprises a leg extension, wherein the leg extension includes a first end joined with a bottom contact surface of the upper leg and a second end extending toward the spring-like hinge.

30. The clamp of claim 29 further comprising a cylindrical edge formed at the second end of the leg extension.

31. The clamp of claim 29 further comprising a bracing member extending between the second end of the leg extension and the upper leg.

32. The clamp of claim 27 further comprising a gripping pattern formed on the respective contact surfaces of the upper and lower legs.

33. The clamp of claim 32, wherein the gripping pattern comprises a surface topography capable of operative engagement for gripping materials disposed therebetween.

34. The clamp of claim 27, wherein the upper leg includes an upturned gripping portion disposed opposite the spring-like hinge.

35. The clamp of claim 34, wherein the upper leg is curved between the spring-like hinge and the upturned gripping portion.

36. A fastener for use on a scrapbook page, the fastener comprising:
a base having an upper face and a substantially flat lower face;
a raised portion connected to the upper face of the base, the raised portion including an outer perimeter; and
a cap having an inner face and an outer face, the cap being capable of operative engagement with the raised portion for securing materials between the cap and the base.

37. The fastener of claim 36 further comprising at least one channel, wherein each channel creates a pathway between channel openings spaced along the outer perimeter of the raised portion.

38. The fastener of claim 37, wherein the at least one has a serpentine shape.

39. The fastener of claim 36 further comprising a post extending from the inner face of the cap for engaging a post-receiving opening in the raised portion of the cap.

40. The fastener of claim 39, wherein the post and the post-receiving opening in the raised portion are threaded.

41. The fastener of claim 39, wherein the post is disposed in a center of the cap.

42. The fastener of claim 36 and further comprising a first lip disposed at or near a perimeter of the cap and a second lip disposed along the outer perimeter of the raised portion, wherein the first and second lips are capable of operative engagement where the first lip envelops the second lip.
